(19) United States
(12) Patent Application Publication
(10) Pub. No.: US 2026/0225106 A1
(43) Pub. Date: Aug. 6, 2026

(54) Improved Jaw Crusher

(71) Applicant: Moore-Watson Limited, Falkirk (GB)

(72) Inventor: Thomas Nicholas Watson, Falkirk (GB)

(21) Appl. No.: 19/150,806

(22) PCT Filed: Jan. 30, 2024
(86) PCT No.: PCT/GB2024/050255

§ 371 Date: Jul. 24, 2025

(30) Foreign Application Priority Data
Jan. 30, 2023 (GB) 2301314.7
May 24, 2023 (GB) 2307788.6

(51) Int. Cl. B02C 1/04; B02C 25/00

(52) U.S. Cl. CPC B02C 1/04; B02C 25/00

(57) ABSTRACT

A jaw crusher is provided, the crusher comprising a frame with a fixed jaw and a moveable jaw located within the frame such that the frame and jaws between them define a crushing volume. The moveable jaw is mounted upon an eccentric shaft such that the moveable jaw has a reciprocating crushing action. The crusher further comprises at least one biasing member having a first end connected to an upper portion of the moveable jaw, and a second end connected to a fixed portion of the frame. A lubricating shaft and a crusher including such a shaft, and a jaw crusher including a turbine for supplementary power generation, are also provided.

### FIELD OF THE INVENTION

The present invention relates to the fields of mining and material processing. More specifically, the present invention is an improved jaw crusher for crushing rocks, ores and other materials down to a specific size.

### BACKGROUND OF THE INVENTION

A typical jaw crusher comprises a robust, rectangular, high-grade steel main frame, a steel cast moving jawstock, toggle plate, manganese and hard, wear-resistant plates, and a heat-treated forged steel eccentric drive shaft complete with roller bearings and driven by two large diameter heavy cast iron balanced flywheels. These latter drive components provide the recommended revolutions and kinetic energy necessary to move the jawstock and crush rock.

The production capacity of crushed material for known jaw crushers can vary from 1 to 1500 tons per hr (TPH) and the machine may weigh from 10 kg to over 100 tonnes. Known jaw crushers have a generally rectangular main frame designed to accept hard lump rock material at a feed size from 25 mm to 1.5m. The manganese wear plates are normally secured on the jawstock at an angle of between 75 and 90 degrees to the back of the main frame. The jawstock swings through a crushing stroke created by the throw on the eccentric drive shaft. A toggle plate is attached to the bottom of the jawstock at a predetermined length and angle, which is held in place by drawback rods and coil compression springs. The toggle plate creates a crushing motion at the bottom of the jawstock as the eccentric shaft revolves.

The jaw crusher has a material feed opening defined between upper ends of the fixed and moving crusher jaws and wear cheek plates which are secured on each side wall of the steel fabricated main frame. These components collectively determine the maximum lump size of hard rock that can enter the top feed access of the crusher. The final TPH and required product size of the crushed material are determined by the dimension between the two side cheek wear plates and the close side setting (CSS) of the moving and fixed crushing jaws at the bottom discharge opening. Both sides of the main frame are perpendicular, therefore the inside dimensions between the side plates at the top material access position are the same as the discharge opening defined between the bottom ends of the wear plates on the jaws. The maximum TPH produced by any size or model of jaw crusher is determined and regulated by the dimensions of the CSS and width of the discharge opening at the bottom of the crushing jaws.

For example, the energy required to drive a 1200 mm×900 mm model of toggle jaw crusher is normally 160 KW for a 6/8 pole 940/700 rpm 50/60 Hz, 3 phase electric motor. With the power and speed of the motor fixed, there is little flexibility in the crusher which would allow any kind of improvement in energy efficiency.

Furthermore, starting up a conventional crusher typically requires around three times usual operating power simply to get the crusher into operation, due to the significant weight of the jawstock and the spring force of the compression springs used in the drawback rod arrangement which is connected to the bottom end of the jawstock and the main frame of the crusher to hold the angled toggle plate tight and secure between toggle seats, thus creating a reciprocating movement at the bottom of the jawstock.

In addition, conventional toggle plate arrangements can wear unevenly and quickly or completely fail. This may happen in the event of any misalignment on assembly, roller bearing wear, tramp iron entering the crusher, or where the jawstock and/or eccentric shaft which drives the jawstock are assembled out of alignment, or move out of alignment over time. Misalignment, by even a relatively small margin, can create excessive wear on the toggle plate and seats. This may result in complete failure of the apparatus.

A number of shafts and joints within a crusher need to be lubricated with grease, oil or a resin. These lubricants are applied to an external surface of a shaft or pinion prior to it being assembled as part of the crusher. Often the lubricant will gradually seep or fall away from the lubricated surface over time, increasing the likelihood of excessive wear at the shaft or joint.

It is an aim of the present invention to obviate or mitigate one or more of the aforementioned disadvantages with existing jaw crusher machines.

### SUMMARY OF THE INVENTION

According to a first aspect of the invention there is provided a jaw crusher comprising:
a frame;
a fixed jaw and a moveable jaw located within the frame such that the frame and jaws between them define a crushing volume;
an eccentric shaft upon which the moveable jaw is mounted such that the moveable jaw has a reciprocating crushing action; and
at least one biasing member having a first end connected to an upper portion of the moveable jaw, and a second end connected to a fixed portion of the frame.

Preferably, the jaw crusher further comprises a plurality of biasing members, each biasing member having a first end connected to an upper portion of the moveable jaw, and a second end connected to a fixed portion of the frame.

Preferably, the fixed portion of the frame is located above the upper portion of the moveable jaw, and wherein each biasing member is suspended from the fixed portion of the frame.

Alternatively, the fixed portion of the frame is located below and behind the upper portion of the moveable jaw, and wherein each biasing member is compressed between the upper portion of the moveable jaw and the fixed portion of the frame.

Alternatively, the jaw crusher has a first fixed portion of the frame located above the upper portion of the moveable jaw, and a second fixed portion of the frame located below and behind the upper portion of the moveable jaw, and wherein the plurality of biasing members comprises a first set of biasing members suspended from the first fixed portion of the frame and a second set of biasing members compressed between the upper portion of the moveable jaw and the second fixed portion of the frame.

The first set of biasing members may be a set of tension springs, and the second set of biasing members may be a set of compression springs.

Preferably, the jaw crusher further comprises a toggle plate assembly, the toggle plate assembly comprising:
an adjustment block having a bore with an internal thread;
an adjustment screw rotatably mounted on the frame such that axial movement of the screw relative to the frame is prevented, the screw being located in the bore and having an external thread which cooperates with the internal thread for relative axial movement between the block and the screw;
a first plate member pivotably attached to the rear of the moveable jaw;
a second plate member pivotably attached to the adjustment block; and
a universal coupling attaching the first plate member to the second plate member.

Preferably, the internal thread and the external thread each have a square profile.

Preferably, the toggle plate assembly further comprises a first pivot shaft providing a first pivot joint between the first plate member and the moveable jaw, and a second pivot shaft providing a second pivot joint between the second plate member and the adjustment block, and wherein at least one of the pivot shafts has an external surface which is provided with a plurality of indentations.

Preferably, the indentations are selected from the group comprising dimples and grooves. Preferably, the indentations comprise dimples and the dimples are provided in a linear arrangement. The grooves may be dovetail grooves. Preferably, the dimples and/or grooves are arranged in parallel with a rotational axis of the at least one pivot shaft. Alternatively, the dimples and/or grooves are arranged at an angle to the rotational axis of the at least one pivot shaft.

Preferably, the toggle plate assembly further comprises a shaft having first and second ends, the first shaft end connected to an outer end of the adjustment screw, and the second shaft end connected to a manual adjustment wheel.

Preferably, the toggle plate assembly further comprises:
a driven gear non-rotatably fixed to the shaft adjacent the second shaft end;
a controller in communication with an adjustment motor;
a drive gear adapted to be driven by the adjustment motor; and
a drive member mounted about the drive gear and driven gear such that the axial position of the adjustment block can be varied by the adjustment motor.

Optionally, the jaw crusher further comprises a clutch adapted to disengage the driven gear from the shaft in the event of manual adjustment of the shaft via the adjustment wheel.

The jaw crusher may further comprises a drive motor for driving the eccentric shaft, and a load sensor adapted to sense the electrical load on the main drive motor, wherein the controller is adapted to send signals to the adjustment motor in response to signals from the load sensor.

According to a second aspect of the present invention there is provided a jaw crusher comprising:
a frame;
a fixed jaw and a moveable jaw located within the frame such that the frame and jaws between them define a crushing volume;
an eccentric shaft upon which the moveable jaw is mounted such that the moveable jaw has a reciprocating crushing action; and
a toggle plate assembly, the toggle plate assembly comprising:
   an adjustment block having a bore with an internal thread;
   an adjustment screw rotatably mounted on the frame such that axial movement of the screw relative to the frame is prevented, the screw being located in the bore and having an external thread which cooperates with the internal thread for relative axial movement between the block and the screw;
   a first plate member pivotably attached to the rear of the moveable jaw;
   a second plate member pivotably attached to the adjustment block; and
   a universal coupling attaching the first plate member to the second plate member.

Preferably, the internal thread and the external thread each have a square profile.

Preferably, the toggle plate assembly further comprises a first pivot shaft providing a first pivot joint between the first plate member and the moveable jaw, and a second pivot shaft providing a second pivot joint between the second plate member and the adjustment block, and wherein at least one of the pivot shafts has an external surface which is provided with a plurality of indentations.

Preferably, the indentations are selected from the group comprising dimples and grooves. Preferably, the indentations comprise dimples and the dimples are provided in a linear arrangement. The grooves may be dovetail grooves. Preferably, the dimples and/or grooves are arranged in parallel with a rotational axis of the at least one pivot shaft. Alternatively, the dimples and/or grooves are arranged at an angle to the rotational axis of the at least one pivot shaft.

Preferably, the toggle plate assembly further comprises a shaft having first and second ends, the first shaft end connected to an outer end of the adjustment screw, and the second shaft end connected to a manual adjustment wheel.

Preferably, the toggle plate assembly further comprises:
a driven gear non-rotatably fixed to the shaft adjacent the second shaft end;
a controller in communication with an adjustment motor;
a drive gear adapted to be driven by the adjustment motor; and
a drive member mounted about the drive gear and driven gear such that the axial position of the adjustment block can be varied by the adjustment motor.

Optionally, the jaw crusher further comprises a clutch adapted to disengage the driven gear from the shaft in the event of manual adjustment of the shaft via the adjustment wheel.

The jaw crusher may further comprises a drive motor for driving the eccentric shaft, and a load sensor adapted to sense the electrical load on the main drive motor, wherein the controller is adapted to send signals to the adjustment motor in response to signals from the load sensor.

According to a third aspect of the invention there is provided a shaft having an external surface which is provided with a plurality of indentations for retaining lubricant on the shaft.

The shaft may be a rotating shaft. Alternatively, the shaft may be a shaft for a hinge or pivot joint.

Preferably, the indentations are selected from the group comprising dimples and grooves. Preferably, the indentations comprise dimples and the dimples are provided in a linear arrangement.

Preferably, the dimples and/or grooves are arranged in parallel with a rotational axis of the shaft. Alternatively, the dimples and/or grooves are arranged at an angle to the rotational axis of the shaft.

According to a fourth aspect of the invention there is provided a crusher comprising at least one shaft according to the third aspect of the invention. The crusher may be a jaw crusher or a cone crusher.

According to a fifth aspect of the invention there is provided a jaw crusher comprising:
a frame;
a fixed jaw and a moveable jaw located within the frame such that the frame and jaws between them define a crushing volume;
an eccentric shaft upon which the moveable jaw is mounted such that the moveable jaw has a reciprocating crushing action;
first and second flywheels attached to respective ends of the eccentric shaft;
a drive pulley adapted to receive drive from a motor;
a driven pulley connected to the drive pulley by a transmission, and to the first flywheel by at least one drive element;
a first cowl at least partially enclosing the first flywheel and the driven pulley;
a second cowl at least partially enclosing the second flywheel and the drive pulley;
wherein each flywheel and pulley is provided with a plurality of fan blades which move air as the flywheel or pulley rotates;
   the jaw crusher further comprising:
a turbine housing having a turbine chamber with an upper portion and a lower portion, the turbine chamber containing a rotating impeller;
a first high pressure inlet manifold having a first open end adjacent the first flywheel and a second end fluidly connected to the lower portion of the turbine chamber;
a first low pressure outlet manifold having a first end fluidly connected to the lower portion of the turbine chamber and a second open end adjacent the drive pulley;
a second high pressure inlet manifold having a first open end adjacent the second flywheel and a second end fluidly connected to the upper portion of the turbine chamber; and
a second low pressure outlet manifold having a first end fluidly connected to the upper portion of the turbine chamber and a second open end adjacent the driven pulley.

Preferably, the transmission is a reduction gearbox having an input connected to the drive pulley and an output connected to the driven pulley.

Alternatively, the transmission is a countershaft having a first end connected to the drive pulley and a second end connected to the driven pulley. The countershaft may include a torque limiter adapted to selectively disconnect the driven pulley from the drive pulley.

Preferably, the impeller is a cylindrical impeller having an axis of rotation which is parallel to a longitudinal axis of the frame.

### BRIEF DESCRIPTION OF THE DRAWINGS

Preferred embodiments of the present invention will now be described, by way of example only, with reference to the following drawings:

FIG. 1 is a side view of a first embodiment of a jaw crusher;

FIG. 2 is a view of a first end of the crusher shown in FIG. 1;

FIG. 3 is a section view taken along the line III-III shown in FIG. 2;

FIG. 4 is a view of a second end of the crusher shown in FIG. 1;

FIG. 5 is a perspective view of a toggle plate arrangement of the crusher shown in FIGS. 1-4;

FIG. 6 is a top view of the toggle plate arrangement shown in FIG. 5;

FIGS. 7 and 8 are detail views of the toggle plate arrangement shown in FIG. 5;

FIG. 9 is a partial section view through a part of the toggle plate arrangement;

FIG. 10 is a detail view of a lubricated shaft for use in a jaw crusher;

FIG. 11 is a perspective view of a second embodiment of a jaw crusher;

FIG. 12 is a detail view of the jaw crusher shown in FIG. 11;

FIG. 13 is a top view of the jaw crusher shown in FIG. 11;

FIG. 14 is another detail view of the jaw crusher shown in FIG. 11;

FIG. 15 is a sectional view of a cone crusher employing the type of lubricated shaft shown in FIG. 10;

FIG. 16 is a detail view of an example eccentric bearing used in the cone crusher of FIG. 15; and

FIG. 17 is a detail view of an optional jawstock suspension arrangement for the jaw crusher shown in FIGS. 1-4.

### DETAILED DESCRIPTION OF THE DRAWINGS

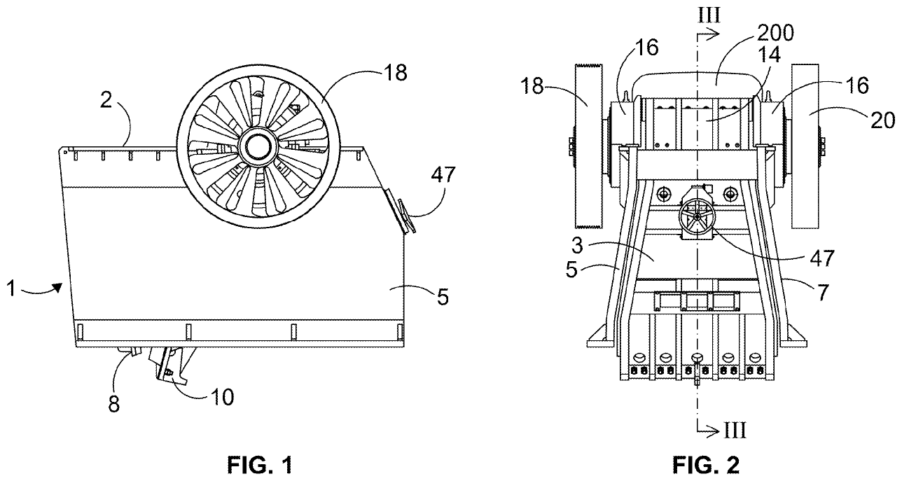

Improved jaw crushers for crushing rock, ores and similar materials are shown in the accompanying figures. A first example of a jaw crusher, generally designated 1, is shown in FIGS. 1-4. The jaw crusher 1 comprises a steel main frame 2 having a pair of generally longitudinal side walls 5,7. At one end of the frame 2 is a fixed jaw 8 and at the opposite end of the frame is an end wall 3. The frame 2 is consequently generally cuboidal and has a feed opening 4 at the top of the frame and a discharge opening 6 at the bottom of the frame. The frame 2 may sit upon a supporting skid frame, or base plate, and/or have two pairs of support legs (neither shown). Extending from the rear of the fixed jaw 8 are a number of generally horizontal support plates 13 which are attached to the side walls 5,7 to provide support to the fixed jaw.

As with known jaw crushers, the present jaw crusher 1 includes a fixed jaw 8 and a moveable jaw, or jawstock, 10. It is the movement of the jawstock 10 relative to the fixed jaw 8 which crushes the material entering the frame 2 through the feed opening 4. Both the fixed jaw 8 and jawstock 10 are covered by replaceable wear plates 9,11. Each wear plate 9,11 may be a single piece or alternatively may be modular, with a number of sections making up the whole. The fixed jaw 8 and jawstock 10 define lateral walls of a crushing volume within the frame 2, and a pair of cheek plates 12 are attached to the inside surfaces of the longitudinal side walls 5,7 of the frame so as to define a pair of longitudinal walls of that crushing volume.

The top of the jawstock 10 is attached to a top bearing cover 14 which houses at least one bearing and an eccentric shaft 30. At the outer ends of the top bearing cover 14 are a pair of bearing caps 16 which cover respective bearings for the eccentric shaft. Each of the bearing caps 16 is attached to an upper surface of the side walls 5,7. Optionally, and as seen in FIG. 2, the frame 2 may further comprises a suspension housing 200 which extends laterally across the frame above the jawstock assembly and which is supported on either side by the side walls 5,7 of the frame. At least a portion of the housing 200 may be integrally formed with at least one of the side walls 5,7, or else the housing may be separately formed and then mechanically fixed to the side walls.

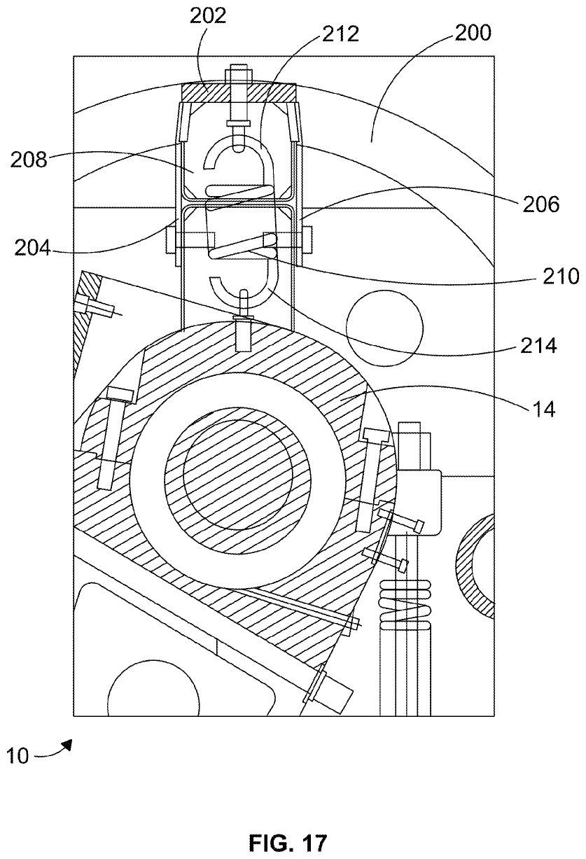

FIG. 17 is a detail section view which shows the suspension housing 200 and the contents thereof in more detail. The housing has a top plate 202 which extends laterally across the frame 2. Extending downwards from either side of the top plate 202 are a pair of side walls 204,206 such that the top plate and side walls at least partially define a suspension chamber 208 within the housing 200. Within the suspension chamber 208 are one or more tension springs 210, the or each tension spring 210 have a top end 212 attached to the housing 200 (by way of the top plate 202 in the illustrated embodiment) and a bottom end 214 attached to the bearing cover 14 of the jawstock 10. The first and second ends 212,214 of each spring 210 are secured to their respective components by suitable mechanical fixtures such as threaded bolts or the like. Thus, when the suspension arrangement is employed the eccentric movement of the jawstock 10 is aided by the or each tension spring 210 in the suspension arrangement.

Connected to either end of the eccentric shaft 30 are first and second flywheels 18,20. The first flywheel 18 is preferably grooved or otherwise adapted to receive one or more drive belts. The other end of the, or each, drive belt is wound around a drive pulley, which is driven by an electric motor through a transmission, which may take the form of a reduction gearbox or else a countershaft and drive pulley arrangement. For illustrative purposes none of these drive components is shown with this first embodiment of the jaw crusher, but is shown and described in more detail below in respect of the second embodiment.

FIGS. 2 and 4 are views of the opposing ends the jaw crusher 1. These end views illustrate that the fixed jaw 8 and end wall 3 taper outwards from top to bottom. The jawstock 10 and the wear plates 9,11 associated with the fixed jaw 8 and jawstock 10 also taper outwards in the same manner as the fixed jaw 8 such that they are wider at their respective bases than at their tops. The side walls 5,7 and cheek plates (not shown in FIGS. 2 and 4) attached to the interior surface of the respective side walls each have a concave profile so as to cooperate with the tapered end wall 3, the fixed jaw 8, jawstock 10 and wear plates 9,11 inside the frame 2.

This tapered arrangement means that the discharge opening 6 at the bottom of the frame 2 is wider than the feed opening 4 at the top of the frame. The feed opening 4 will be of a conventional size, such as 900 mm wide by 600 mm long, 1100 mm by 800 mm, or 1200 mm by 900 mm, for example. The discharge opening 6 may be at least one third wider than the feed opening 4. For example, the feed opening may be 900 mm wide and the discharge opening may be 1200 mm wide. Alternatively, the discharge opening 6 may be at least one third wider, and no more than two times wider, than the feed opening 4. In a further alternative, the opening 6 may be at least one third wider, and no more than 50% wider than the feed opening 4.

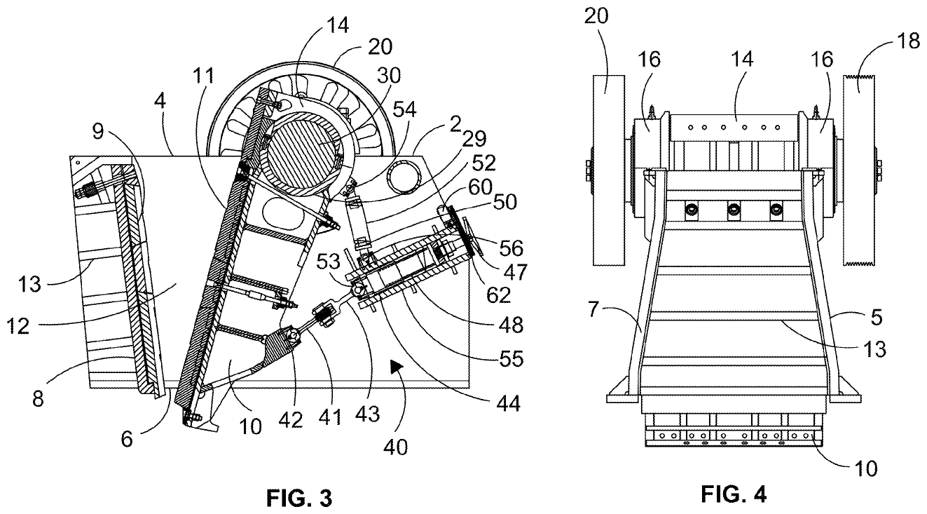

FIG. 3 is a longitudinal section taken through the jaw crusher 1 along the line III-III shown in FIG. 2. This section helps illustrate the various components which make up the complete jawstock assembly in particular. As already described, the feed opening 4 and the discharge opening 6 each have a respective fixed width. However the length, or close side setting (CSS), of the feed and discharge openings 4,6 is variable and is dictated by the angular positioning of the jawstock 10. An eccentric shaft bearing seat, or channel, 29 runs across an upper end of the jawstock 10 and the eccentric shaft 30 is located in the seat and encapsulated by the top bearing cover 14. The angle of the jawstock 10 is adjusted via a toggle plate assembly 40, which has a first toggle plate 41 pivotably attached to a first toggle seat or hinge bracket 42 in a lower end of the jawstock, and a second toggle plate 43 pivotably attached to an adjustment block 44. Adjusting the adjustment block 44 adjusts the longitudinal position of the toggle plate assembly 40 relative to the frame 2. With the longitudinal position of the upper end of the jawstock 10 fixed on account of the eccentric shaft 30 this longitudinal adjustment of the toggle plate 40 will adjust the angle of the jawstock 10. This will also vary the CSS and the overall cross sectional area of the discharge opening 6.

A biasing assembly is also provided for the jawstock 10. This biasing assembly comprises a number of compression springs 50, each of which is housed within an extendable spring housing 52. A first, or top, end 54 of each spring is connected to an upper portion of the jawstock 10 whilst a second, or bottom, end 56 of each spring is connected to an upper cross member 53 of the frame 2. The biasing assembly comprises at least one biasing spring mounted between the upper end of the jawstock 10 and the frame 2, preferably by way of the upper cross member 53. The biasing assembly may comprise any suitable number of such springs. Preferably, the biasing assembly has four such springs although only one is visible in FIG. 3.

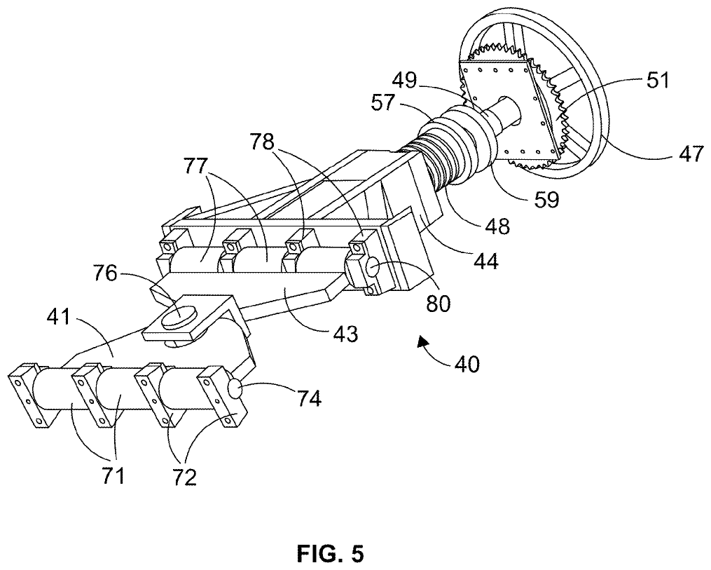

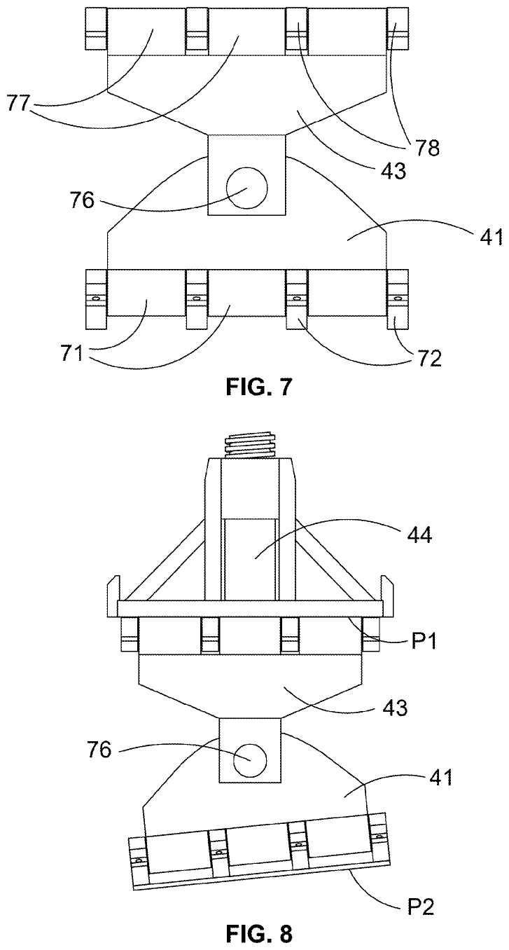

The toggle plate assembly will be described in more detail with respect to FIGS. 5-8, but a brief description is as follows. The adjustment block 44 is preferably housed between the upper cross member 53 and a lower cross member 55. The block 44 takes the form of a hollow body with a threaded internal bore. Located in the bore is an adjustment screw 48 with an external thread cooperating with the internal thread of the bore. The thread may have a substantially square profile so as to prevent relative movement between the screw 48 and block 44 unless an adjustment is desired. Alternatively the thread may be a buttress or sawtooth thread, which have a partly square profile with one thread face square and the other angled.

The screw is provided with a pair of flange members 57,59 which following assembly are located either side of a fixed portion of the crusher frame. This arrangement of flanges and frame ensures that the screw is fixed in the axial/longitudinal direction whilst being able to rotate relative to the frame. A manual adjustment wheel 47 is located outside the adjustment block 44 and connected to a first end of the adjustment screw 48. Given that the screw is axially fixed in position, rotation of the wheel 47 moves the block 44 axially back and forth upon the screw 48, depending on the rotational direction of the wheel 47 and screw 48. An electric actuator 60 is also provided and connected to a first end of the screw 48 by a drive chain or belt 62. A clutch (not shown) is provided so that manual adjustment of the screw 48 can be undertaken whilst not damaging the motor 60 and associated drive components. A load sensor and controller (not shown) may be provided on the motor of the crusher so as to determine when the motor is overloaded due to one or more foreign objects in the crushing volume. In such an instance the controller may instruct the actuator on the adjustment screw to rotate the screw so as to pull out the adjustment block 44, thereby opening up the CSS by pulling back the jawstock 10 and allowing the objects to drop out of the crushing volume before the crusher frame and/or jaw(s) is/are damaged.

FIGS. 5-8 show the toggle plate assembly 40 in more detail. As can be seen the first toggle plate 41 has a first end which is connectable to the first toggle seat 42 on the jawstock 10. The first end of the first toggle plate 41 has a number of cylindrical elements 71 and at either end of each cylindrical element 71 are flanges 72 for connecting the first toggle plate 41 to the first toggle seat using bolts or other suitable mechanical fastenings. When bores within the cylindrical elements 71 and flanges 72 are aligned a first pivot shaft 74 can be extended through the co-axial bores such that the first toggle plate 41 and the jawstock 10 can pivot relative to one another about the pivot shaft 74.

Second ends of the first toggle plate 41 and second toggle plate 43 are connected to each other by a universal joint 76 such that the toggle plates 41,43 may yaw and roll relative to one another to over a relatively small amount (e.g. ±5 degrees) when all of the components of the toggle plate assembly 40 are connected to one another. The degree of yaw permitted is illustrated in FIG. 8, where the pivot axis P1 of the first pivot shaft 74 may be at an angle of up to 5 degrees relative to a pivot axis P2 of a second pivot shaft 80.

A first end of the second toggle plate 43 has a similar arrangement to the corresponding end of the first toggle plate 41. As such the first end of the second toggle plate 43 has a number of cylindrical elements 77 and at either end of each cylindrical element 77 are flanges 78 for connecting the second toggle plate 43 to a mounting plate 81 of the adjustment block 44 using bolts or other suitable mechanical fastenings. When bores within the cylindrical elements 77 and flanges 78 are aligned the second pivot shaft 80 can be extended through the co-axial bores such that the second toggle plate 43 and the adjustment block 44 can pivot relative to one another.

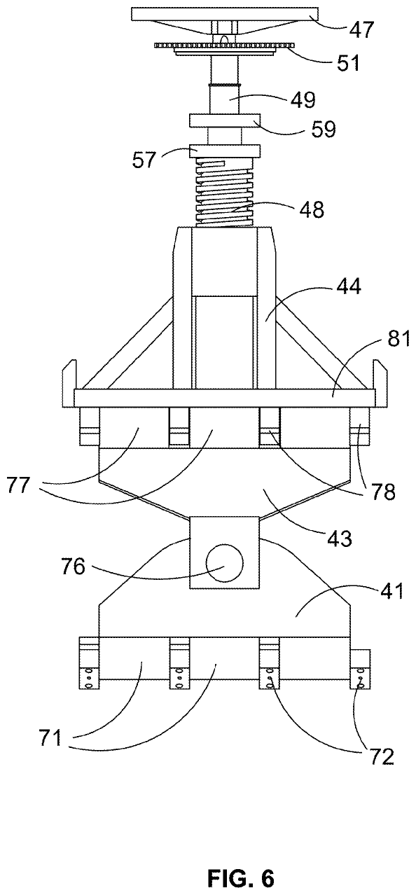

As can be seen in FIGS. 5 and 6, the manual adjustment wheel 47 is located outside the adjustment block 44 and connected to a first end of the adjustment screw 48 via a shaft 49 upon which the flanges 57,59 which prevent axial movement of the screw are also provided. As described above, rotation of the wheel 47 rotates the screw 48 but the screw cannot move axially due to the abutment of the flanges 57,59 with a portion of the crusher frame (not shown in FIGS. 5 and 6). Consequently, rotation of the screw 48 results in a axial movement of the block 44 along the screw so as to move the jawstock 10 and either increase or decrease the size of the discharge opening 6.

A drive gear 51, preferably a worm drive gear or helical drive gear, is mounted to the shaft 49 and this will receive the drive chain connected to the electric actuator (neither shown in FIGS. 5 and 6) for automated adjustment of the screw 48 and block 44.

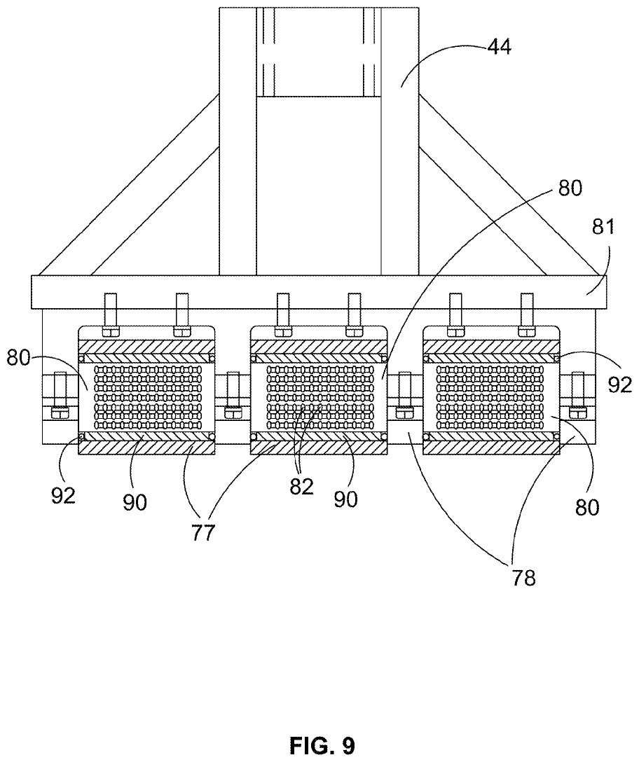

FIG. 9 is a partial section view of the adjustment block 44 and first end of the second toggle plate 43. This illustrates the pivot shaft arrangements used both between the adjustment block 44 and second toggle plate 43, and between the jawstock 10 and the first toggle plate 41.

The cylindrical elements 77 at the first end of the second toggle plate 43 which lie between each pair of flanges 78 are illustrated in section so that the internal components within those cylindrical elements 77 can be seen. Within each cylindrical element 77 is a cylindrical bearing 90 which has an annular seal 92 at either end thereof. Thanks to the section view, it can be seen that the second pivot shaft 80 which extends through the cylindrical elements 77 and flanges 78 is provided with a number of dimples or indentations 82 in the external surface thereof. A lubricating grease, oil or resin is applied to the external surface of the shaft 80 prior to it being inserted into the joint. The dimples or indentations 82 help retain the lubricant about the circumference of the shaft, thus improving the consistency and longevity of the lubrication at the pivot joint. The lubricant used may set or cure in place on the shaft such that it is load-bearing. Consequently, the shaft is not weakened by the dimples or indentations formed thereon.

This new design of toggle plate does not require a drawback rod and strong force compression springs to hold the toggle plate in place while in operation, thus reducing the energy required to start and drive the crusher. This new design of toggle plate may be fitted to all types of jaw crusher and adjustment systems.

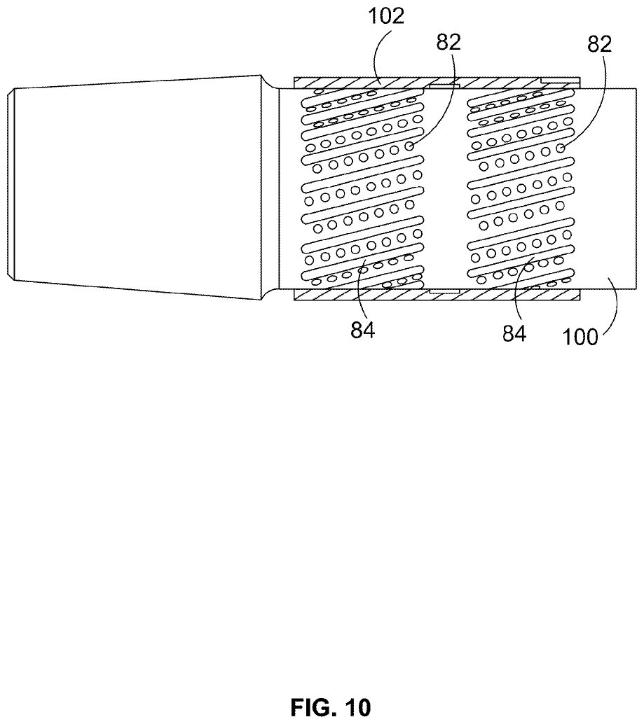

As stated above, this lubricated shaft arrangement is used for the first pivot shaft as well as the second pivot shaft. It may also be used for any shaft, pivot or hinge arrangement where improved lubrication is desired. An alternative example of such a shaft arrangement is shown in FIG. 10. Here, the external surface of a shaft 100 within a bearing 102 has not only dimples or indentations 82 but also elongate grooves 84 for retaining lubricant on the shaft. The dimples 82 and grooves 84 can be arranged in a number of ways, such as parallel to the rotational axis of the shaft 100 or, as illustrated in FIG. 10, in alternating formation extending circumferentially around the shaft 100 with lines of dimples 82 and grooves angled relative to the rotational axis. Alternatively, the shaft 100 may be provided with grooves alone. Again, these alternative shaft arrangements are not limited to use in the toggle plate assembly or jaw crusher described herein. They may be used in any hinge, joint or rotating shaft where improved lubrication is needed.

The grooves in the shaft can be cut in a dovetail design where the bottom of the groove is wider than the opening at the top. This shape of groove will take a good hold and retain the grip of the lubricant, where the dimples/grooves are positioned and sized on the basis of one or more of the following parameters: application of joint; shaft diameter; shaft rotational speed; shaft or joint working temperature. The preferred special high volume graphite resin solution also works as a dry lubricant that is applied to the dimples and machine cut grooves on the shaft in paste form. The paste will go extremely hard by chemical reaction and will be machined to the lubrication working diameter of the shaft. The machine cut grooves and dimples will have a design pattern to suit the application. The dry graphite lubricant will work at high temperature and remain in position on the shaft. This will be extremely useful when applied to shafts with less than one full revaluation or minimum movement is only required. The new system of shaft or other component dimple/groove lubrication can be applied to many applications from knuckle movement to high rpm using several different designs of grooves and types of lubricants and will greatly extend time in operation of the relevant joint(s).

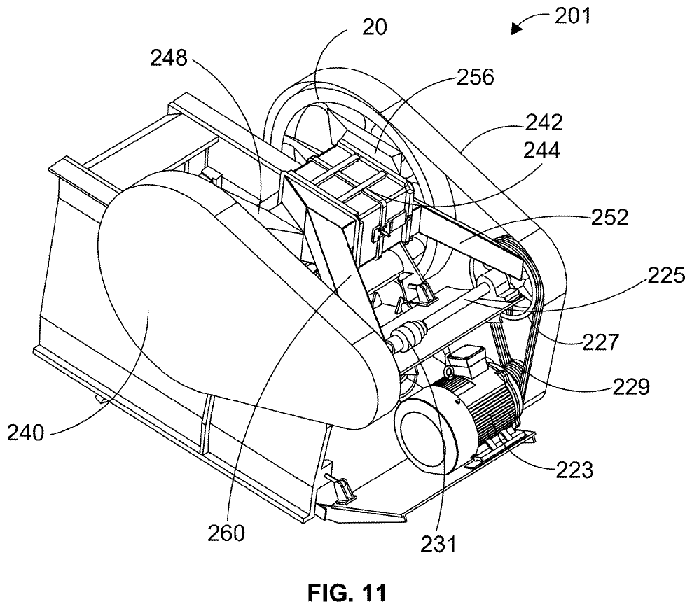

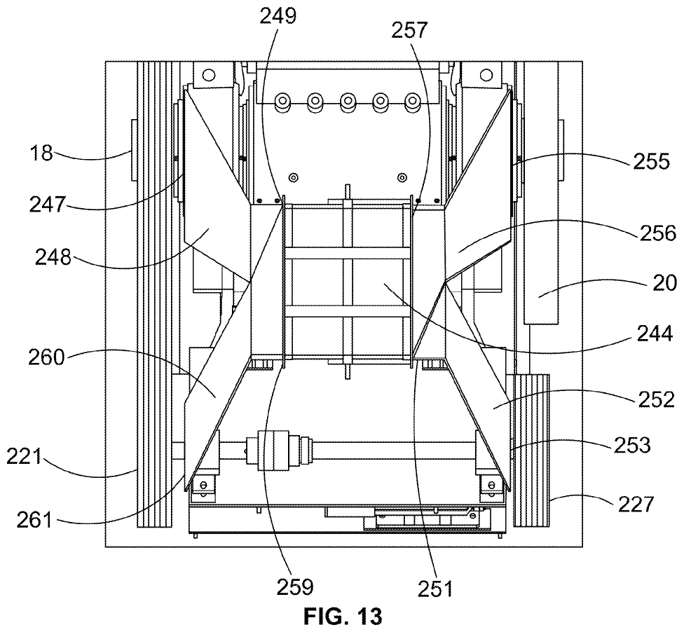

FIGS. 11-14 show views of a second example of a jaw crusher, designated 201. Unless otherwise stated it should be understood that the second example shares the features of the first example described above.

As with the first example, the first flywheel 18 is adapted to receive one or more flywheel drive belts 219. The other end of the, or each, flywheel drive belt 219 is wound around a driven pulley 221. The driven pulley 221 is attached to one end of a countershaft 225, where the opposite end of the countershaft 225 is attached to a drive pulley 227. The drive pulley 227 is driven by a high speed (e.g. 1540/1800 rpm) electric motor 223 via a motor drive belt 229. A torque limiter 231 may be provided on the countershaft 225 so as to break drive and protect the crusher frame and/or jaws in the event that the jawstock 10 encounters an obstruction, such as a steel tooth or the like, which has entered the crushing volume of the crusher 201. The countershaft arrangement may be replaced with a reduction gearbox if desired.

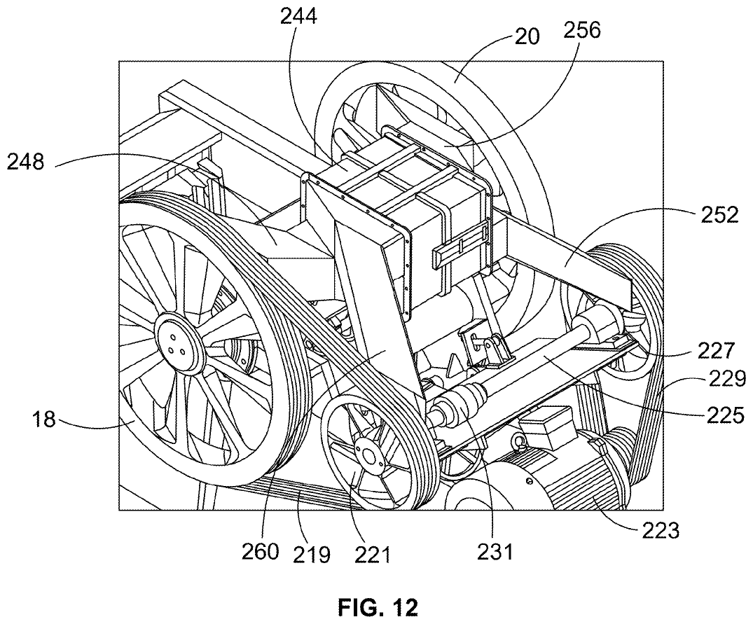

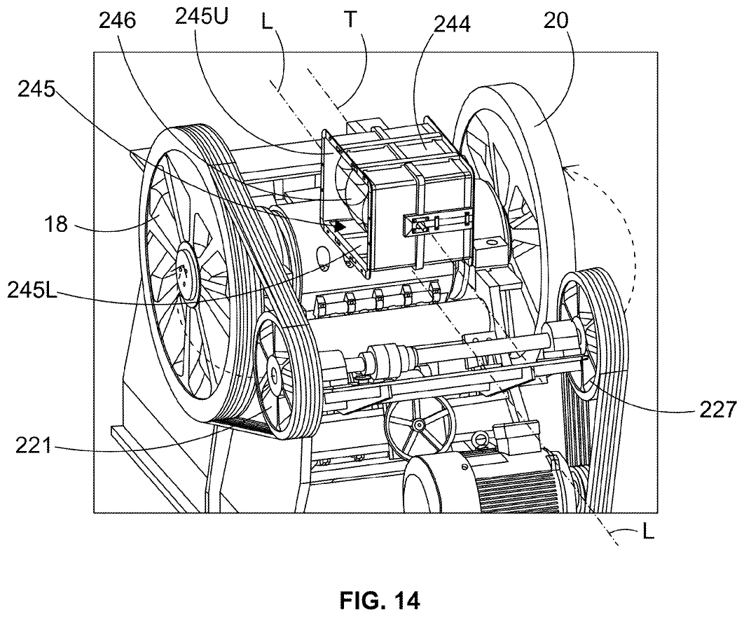

Each of the flywheels 18,20 and pulleys 221,227 is provided with fins or blades, as best seen in FIGS. 12 and 14. These fins or blades move the surrounding air as their respective flywheel or pulley rotates. The driven pulley 221 and first flywheel 18 are housed within a first cowl 240, whilst the second flywheel 20 and drive pulley 227 are housed within a second cowl 242.

Mounted upon the crusher is a turbine housing 244 defining a turbine chamber 245 which has an upper portion 245U and a lower portion 245L. Referring to FIG. 14 one can see that within the turbine chamber 245 is a cylindrical impeller 246, which is mounted to rotate about a rotational axis T which is substantially parallel to a longitudinal axis L of the jaw crusher 201. Connected to the turbine housing 244 are two pairs of turbine manifolds. A first high pressure turbine inlet manifold 248 has a first open end 247 adjacent the first flywheel 18 and a second open end 249 connected to the lower portion 245L on a first side of the turbine chamber 245. A first low pressure turbine outlet manifold 252 has a first open end 251 connected to the lower portion 245L on a second side of the turbine chamber 245, and a second open end 253 adjacent the drive pulley 227. A second high pressure turbine inlet manifold 256 has a first open end 255 adjacent the second flywheel 20 and a second open end 257 connected to the upper portion 245U on the second side of the turbine chamber 245. A second low pressure turbine outlet manifold 260 has a first open end 259 connected to the upper portion 245U on the first side of the turbine chamber 245, and a second open end 261 adjacent the driven pulley 221.

The cowls and manifolds are removed in FIG. 14 so that one can see the “figure of 8” flow of compressed air which moves through the manifolds and cowls under the action of the flywheels and pulleys. High pressure air flow is generated by each of the flywheels 18,20 and as the compressed air passes through the upper and lower portions 245U, 245L of the turbine chamber 245 from opposing directions the turbine will rotate about its turbine axis T, thereby creating energy at the rotor shaft. The low pressure spent air flows through the respective outlet manifolds to either the driven pulley 221 or drive pulley 227, and from there it is directed back to a flywheel 18,20 by the respective cowls 240,242. The turbine is non-rotatably connected to a turbine shaft (not shown) which lies on the turbine axis T. At the end of the turbine shaft is a turbine pulley and belt drive which connected to a dedicated generator (none shown). The generator produces power for consumption by the crusher motor 223, one or more auxiliary components, or may be sent to a battery bank of a known type.

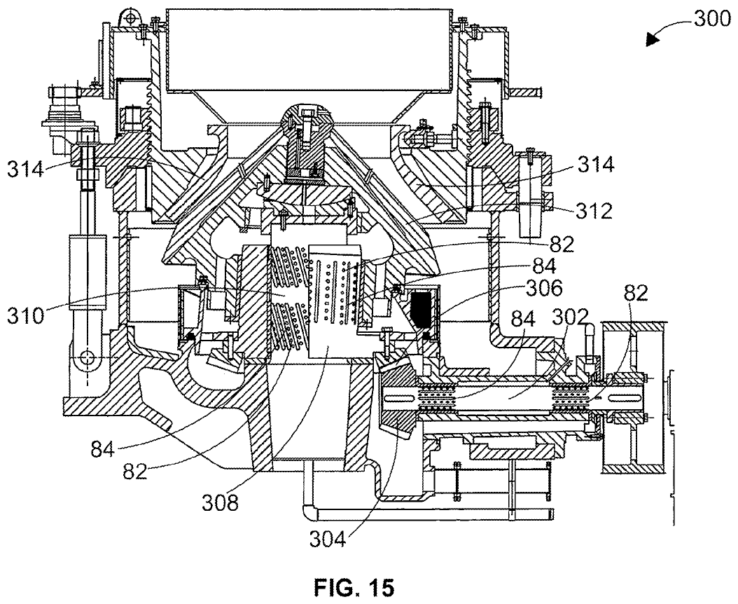

FIG. 15 shows a vertical section through a cone crusher, where several of the shafts used therein are provided with the same lubricant-retaining arrangement as described above with respect to FIGS. 9 and 10. The cone crusher, generally designated 300, employs a gyratory motion in order to crush a product. A drive shaft 302 has a first end connected to a belt drive and motor (neither shown) and a second end which is provided with a pinion gear 304. The pinion gear 304 engages a crown gear 306 which lies at the bottom end of an eccentric bearing 308. Located inside the eccentric bearing is a main shaft 310 whose upper end is connected to a crushing mantle 312 which lies against an outer surface of the eccentric bearing 308. The main shaft 310 also has a lower end which is fixed to the main frame of the crusher such that the main shaft does not rotate. As the eccentric bearing 308 rotates under drive from the motor it causes the mantle 312 to rotate in an elliptical manner about a centreline of the crusher. This causes the mantle 312 to move with respect to fixed concave liners 314 which define a feed inlet for the crusher. As the mantle 312 moves the gaps between the mantle and liners 314 on either side of the centreline vary between a closed side setting and an open side setting These movements occur when no feed material is entering the crusher. However, when feed material does enter the crusher the mantle 312 will be prevented from rotating under the action of the eccentric bearing 308 due to the presence of the feed material and leads to the crushing of that material (e.g. rock).

As can be seen in FIG. 15 the external surfaces of the drive shaft 302, eccentric bearing 308 and main shaft 310 are each provided with dimples or indentations 82 and elongate grooves 84 for retaining lubricant on the respective external surfaces. The dimples 82 and grooves 84 on the drive shaft are arranged in an alternating formation in parallel to a rotational axis of the drive shaft 302. In contrast the surfaces of the eccentric bearing 308 and main shaft 310 have dimples/indentations 82 and grooves 84 in alternating formation extending circumferentially around the shaft 100 with lines of dimples 82 and grooves angled relative to the rotational axes of those respective components.

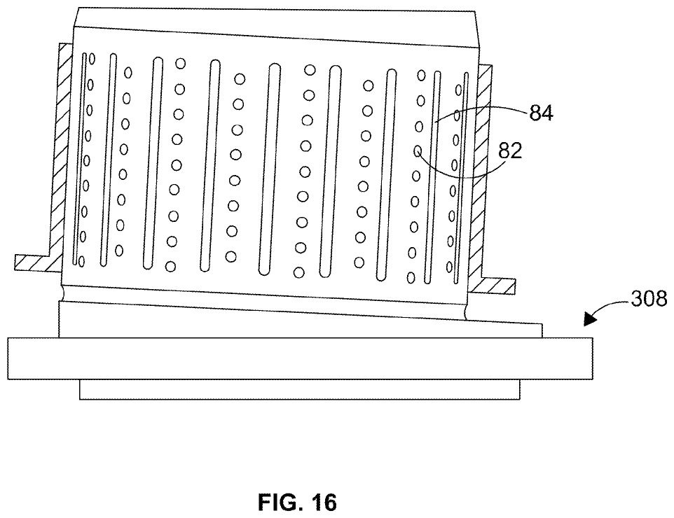

FIG. 16 is a detail view of the eccentric bearing 308 used in a cone crusher. Similar to the shaft arrangement of FIG. 10, the dimples 82 and grooves 84 of the eccentric bearing 308 may be filled with the high percentage graphite paste designed to harden by chemical reaction, or any other appropriate lubricant. The dimples and grooves may be arranged in the same way as described in respect the FIG. 10 embodiment.

The present invention provides a more energy-efficient jaw crusher as providing at least one biasing spring between the upper end of the jawstock and the frame reduces the amount of power needed to start up the crusher and initially move the jawstock from a rest position. These springs may completely support the total weight of the jawstock, thereby allowing the use of a less power consuming electric drive motor. In addition, the new toggle plate assembly removes the conventional drawback rods and springs from the jawstock that contribute additional forces which must be overcome to get the jawstock initially moving. Furthermore, the new toggle plate assembly provides a small degree of relative movement in yaw and roll between the two toggle plates, such that if the jawstock and/or eccentric shaft are not in perfect alignment at assembly or while in operation it will still function properly and avoid excessive wear.

The new design multi swivel, self-aligning toggle plate is directly connected to the jawstock and adjustment slide frame bracket. Therefore no drawback rods are required. This will reduce the power required to drive the crusher flywheel by not having coil spring compression tension on every revolution, and in particular the significant load on the electric motor when starting.

The toggle plate hinge connection brackets are securely bolted to the bottom of the jawstock and the adjustment slide frame. The end brackets may be connected to the toggle plate by piano hinge clevis design and steel shaft/pin. The cylindrical face of this swivel hinge pin/shaft has several purpose designed indents and special shaped CNC cut grooves. These are filled with the high volume graphite resin solution that when hard by chemical reaction, are machined to the lubrication shaft diameter to give permanent lubrication while in operation. The toggle plate/bracket hinge bearings are sealed to retain lubrication and prevent the interference of water and dust to the bearing. The universal swivel toggle plate connection pin is also graphite lubricated. This new design multi swivel toggle plate will accommodate for any misalignment between the jawstock and crusher main frame at assembly or caused by normal wear while in operation.

The present invention provides an eccentric shaft continuous drive weight reduction thanks to the compression coil springs fitted between the crusher main frame and the top section at the back of the jawstock. The tensioned springs will take a substantial weight off the suspended jawstock, load off the eccentric shaft and electric motor drive. A robust cross beam can be secured to the main frame bearing cap bolts between the flywheels, with expansion coil springs connected by hook to the centre of the jawstock top bearing cover and tensioned to take a significant weight off the eccentric shaft and motor drive.

The close side setting (CSS) screw adjustment system is a compact, simple, practical, automatic or manual hand wheel operation. The threaded die block slide frame is directly connected to the swivel hinge bracket of the toggle plate. The screw adjustment regulates the close side setting (CSS) at the bottom discharge opening of the crusher. The screw shaft adjustment may be operated by an electric motor double reduction worm gearbox directly linked to the crusher drive motor by a load sensor. In the event of a foreign object entering the crushing chamber the sensor would react to the excess load above the normal working energy requirement. The screw adjustment will automatically open the discharge setting to maximum, allowing space for the foreign object to fall through and then reset the discharge CSS to the original working position. The electric motor gearbox drive connection to the screw shaft is by clutch, which can be used when manual hand wheel adjustment is necessary.

A turbine fitted with a double drive turbine rotor is positioned between the flywheels at the back of the jawstock. The rotor inserted to the centre of the wind tunnel is propelled by a continuous flow of pressurized air generated by the large diameter fan blade spoke crusher flywheels while in operation. The pressurized airflow is directed to the top & bottom section of the rotor on both sides of the tunnel by an airflow manifold fitted between the inside of the flywheels and the wind tunnel. Pressurized airflow from one flywheel is directed to the top section of the rotor on one side of tunnel and directed to the bottom section of the rotor from the other flywheel on the opposite side of the tunnel. The spent pressurized airflow from the top and bottom rotor blades is blown through the manifold to the top inside section of the cast iron Vee belt fan spoke drive pulleys. The fan type drive pulleys are turning at a higher rpm than the crusher flywheels so the spent pressurized air is immediately sucked in by the high speed fan blade spokes on drive pulleys. The super charged air is directed to the correct position on the crusher flywheels by a channel incorporated in the design of the drive belt cowls or shrouds. The super charged air directed to the flywheels is further pressurized by the large diameter fan blade spoke flywheels and blown into the wind turbine rotor. The rotor shaft will be linked to a dynamo (by drive pulley and belt) mounted on the turbine and will generate energy that can be used to power the plant or feed to a storage battery or the power grid.

A reduction drive allows the fitment of a larger diameter drive pulley, this will increase the area of the V belt grip and will therefore reduce the amount of V grooves required on both the drive pulley and crusher flywheels, which will reduce the width of the drive pulleys, flywheels and guards/cowls. This in turn will lower the manufacturing costs.

Whilst the preferred examples of the jaw crusher shown and described herein have a tapered body, the present invention is not to be limited to such an arrangement. The inventive features described herein may equally be employed in a jaw crusher of a more conventional body shape, where the feed and discharge openings have substantially the same dimensions.

The jaw crusher of the present invention may employ the tension spring suspension alone, the compression spring suspension alone, or else both in the same apparatus.

In the preferred embodiments of the jaw crusher described above the first flywheel is indirectly driven by the electric motor through a transmission, which may take the form of a reduction gearbox or else a countershaft and drive pulley arrangement. However, the first flywheel may alternatively be directly driven off the electric motor, with a drive pulley directly connected to a drive shaft of the electric motor. At least one drive belt connects the drive pulley and first flywheel such that the drive from the motor is sent directly to the flywheel.

Although the biasing members used in the preferred embodiment of the jaw crusher to support the jawstock are tension and compression springs, respectively, other biasing members may be used. Other types of spring may be employed, or else solid elastomeric members may be used, e.g. suitably adapted rubber blocks.

Other modifications and improvements may be incorporated without departing from the scope of the present invention as defined by the appended claims.

1. A jaw crusher comprising:
a frame;
a fixed jaw and a moveable jaw located within the frame such that the frame and jaws between them define a crushing volume;
an eccentric shaft upon which the moveable jaw is mounted such that the moveable jaw has a reciprocating crushing action; and
at least one biasing member having a first end connected to an upper portion of the moveable jaw, and a second end connected to a fixed portion of the frame.

2. The jaw crusher of claim 1, further comprising a plurality of biasing members, each biasing member having a first end connected to an upper portion of the moveable jaw, and a second end connected to a fixed portion of the frame.

3. The jaw crusher of claim 2, wherein the fixed portion of the frame is located above the upper portion of the moveable jaw, and wherein each biasing member is suspended from the fixed portion of the frame.

4. The jaw crusher of claim 2, wherein the fixed portion of the frame is located below and behind the upper portion of the moveable jaw, and wherein each biasing member is compressed between the upper portion of the moveable jaw and the fixed portion of the frame.

5. The jaw crusher of claim 2, wherein the jaw crusher has a first fixed portion of the frame located above the upper portion of the moveable jaw, and a second fixed portion of the frame located below and behind the upper portion of the moveable jaw, and wherein the plurality of biasing members comprises a first set of biasing members suspended from the first fixed portion of the frame and a second set of biasing members compressed between the upper portion of the moveable jaw and the second fixed portion of the frame.

6. The jaw crusher of claim 5, wherein the first set of biasing members are tension springs and the second set of biasing members are compression springs.

7. The jaw crusher of claim 1, further comprising a toggle plate assembly, the toggle plate assembly comprising:
an adjustment block having a bore with an internal thread;
an adjustment screw rotatably mounted on the frame such that axial movement of the screw relative to the frame is prevented, the screw being located in the bore and having an external thread which cooperates with the internal thread for relative axial movement between the block and the screw;
a first plate member pivotably attached to the rear of the moveable jaw;
a second plate member pivotably attached to the adjustment block; and
a universal coupling attaching the first plate member to the second plate member.

8. The jaw crusher of claim 7, wherein the internal thread and the external thread each have a square profile.

9. The jaw crusher of claim 7, wherein the toggle plate assembly further comprises a first pivot shaft providing a first pivot joint between the first plate member and the moveable jaw, and a second pivot shaft providing a second pivot joint between the second plate member and the adjustment block, and wherein at least one of the pivot shafts has an external surface which is provided with a plurality of indentations.

10. The jaw crusher of claim 9, wherein the indentations are selected from the group comprising dimples and grooves.

11. The jaw crusher of claim 10, wherein the indentations comprise dimples and the dimples are provided in a linear arrangement.

12. The jaw crusher of claim 11 wherein the dimples and/or grooves are arranged in parallel with a rotational axis of the at least one pivot shaft.

13. The jaw crusher of claim 11, wherein the dimples and/or grooves are arranged at an angle to the rotational axis of the at least one pivot shaft.

14. The jaw crusher of claim 7, wherein the toggle plate assembly further comprises a shaft having first and second ends, the first shaft end connected to an outer end of the adjustment screw, and the second shaft end connected to a manual adjustment wheel.

15. The jaw crusher of claim 14, wherein the toggle plate assembly further comprises:
a driven gear non-rotatably fixed to the shaft adjacent the second shaft end;
a controller in communication with an adjustment motor;
a drive gear adapted to be driven by the adjustment motor; and
a drive member mounted about the drive gear and driven gear such that the axial position of the adjustment block can be varied by the adjustment motor.

16. The jaw crusher of claim 15, further comprising a clutch adapted to disengage the driven gear from the shaft in the event of manual adjustment of the shaft via the adjustment wheel.

17. The jaw crusher of claim 15, further comprising a drive motor for driving the eccentric shaft, and a load sensor adapted to sense the electrical load on the main drive motor, wherein the controller is adapted to send signals to the adjustment motor in response to signals from the load sensor.
